(19) United States
(12) Patent Application Publication
(10) Pub. No.: US 2004/0265514 A1
(43) Pub. Date: Dec. 30, 2004

(54) Ink-jet recording material and method for preparing the same

(76) Inventors: Hiroshi Sakaguchi, Tokyo (JP); Yukio Tokunaga, Tokyo (JP)

Correspondence Address: BIRCH STEWART KOLASCH & BIRCH, PO BOX 747, FALLS CHURCH, VA, 22040-0747, US

(21) Appl. No.: 10/874,216

(22) Filed: Jun. 24, 2004

(30) Foreign Application Priority Data
Jun. 27, 2003 (JP) 2003-184605
Oct. 22, 2003 (JP) 2003-362495

(51) Int. Cl. B41M 5/00

(52) U.S. Cl. 428/32.34

(57) ABSTRACT

There are disclosed an ink-jet recording material comprising a support and at least one ink-receptive layer provided on the support, wherein at least one of the ink-receptive layers contains inorganic particles having an average secondary particle size of about 500 nm or less, a resin binder having a keto group as a resin binder and a compound having two or more primary amino groups in the molecule, and a method for preparing the same.

### BACKGROUND OF THE INVENTION

1. Field of the Invention

The present invention relates to an ink-jet recording material and a method for preparing the same, more specifically to an ink-jet recording material that has photo-like high glossiness, is excellent in ink-absorption property, involves no problem of crack by folding that is a phenomenon in which crack occurs at the portion of a recording material being folded, and has high productivity and a method for preparing the same.

2. Background Art

As a recording material to be used for an ink-jet recording system, a recording material which comprises an ink-receptive layer being provided on a support such as paper or a plastic resin film has been known. The ink-receptive layer can be roughly classified into two types. One of which is an ink-receptive layer mainly comprising a water-soluble polymer, and the other is an ink-receptive layer mainly comprising an inorganic pigment and a resin binder.

In the former type of the ink-receptive layer, ink is absorbed by the water-soluble polymer that is swelling. In the latter type of the ink-receptive layer, ink is absorbed in voids formed by the inorganic pigments. Due to such a difference in mechanism of absorbing ink, the former type is called to as a swelling type (or a polymer type) and the latter is a void type.

In the former type of the ink-receptive layer, glossiness is excellent since it forms a continuous uniform film but ink-absorption property (an ink-absorption rate; a drying rate after printing) is poor. On the other hand, in the latter void type, ink-absorption property is excellent but glossiness is poor.

In recent years, a recording material excellent in both of the ink-absorption property and glossiness has been earnestly desired, and a void type recording material using ultrafine inorganic particles as a pigment has been proposed. For example, it has been proposed to use silica prepared by a gas phase process (hereinafter referred to as “fumed silica”) or a wet type silica (a silica prepared by a wet process) pulverized and dispersed to have an average secondary particle size of 500 nm or less as a pigment for an ink-receptive layer. For example, in Japanese Patent Publication No. Hei. 3-56552, Japanese Unexamined Patent Publications No. Hei. 10-119423, No. 2000-211235 and No. 2000-309157, there have been disclosed to use fumed silica, in Japanese Unexamined Patent Publications No. Hei. 9-286165 and No. Hei. 10-181190, there have been disclosed to use pulverized silica prepared by a precipitation process, and in Japanese Unexamined Patent Publication No. 2001-277712, there has been disclosed to use pulverized silica prepared by a gel process. Moreover, in Japanese Unexamined Patent Publications No. Sho. 62-174183, No. Hei. 2-276670, No. Hei. 5-32037 and No. Hei. 6-199034, there have been disclosed recording materials using alumina or alumina hydrate.

However, when the above-mentioned inorganic particles are used, high glossiness can be obtained but a viscosity of a coating solution tends to be high, whereby coating is carried out with a low solid concentration, so that surface defects such as a wave-like pattern, cracking, etc. likely occur. In particular, when a non-absorptive support such as a polyolefin resin-coated paper (in which a polyolefin resin such as a polyethylene, etc. is laminated on both surfaces of paper) or a polyester film is used to prepare high glossiness or good feel of a material, the support cannot absorb ink, so that an ink-absorption property of an ink-receptive layer provided on the support is important. Accordingly, it is necessary to constitute the ink-receptive layer by a large amount of pigments and a lower ratio of a binder to heighten a void ratio and a void volume of the ink-receptive layer. As a result, a wave-like pattern and cracking are more likely caused at the time of coating and drying of the ink-receptive layer.

To avoid the above-mentioned surface defects, it has been known a method in which a coating solution containing a cross-linking agent is coated onto a support, and drying is then carried out under relatively mild conditions. For example, in Japanese Unexamined Patent Publications No. Hei. 10-119423, No. 2000-27093 and No. 2001-96900, disclosed are methods in which a boron compound such as boric acid, a borate or borax is used as a cross-linking agent of a polyvinyl alcohol, a coating solution is coated and once cooled to increase the viscosity of the coated solution, and the coated material is dried under relatively low temperature. Also, an aldehyde compound, an epoxy compound or an isocyanate compound has been known as a cross-linking agent. However, in these prior art techniques, coating and drying conditions are restricted, so that productivity is lowered. Also, a little change in drying temperature causes remarkable surface defects in some cases.

On the other hand, it has been known to use a resin having an acetoacetyl group in an ink-jet recording material. For example, it has been disclosed in Japanese Unexamined Patent Publications No. Sho. 63-176173, No. Hei. 10-157283, No. 2000-52646, No. 2000-280600, No. 2001-72711 and No. 2001-213045, and Japanese Patent Publication No. Hei. 4-15746.

However, in these prior art techniques, there is no description about resolution of surface defects at the time of preparation, resolution of crack by folding that occurs to handle a recording material and improvement in productivity that are problems involved in an ink-receptive layer that is required to.have photo-like high glossiness and excellent ink-absorption property, i.e., an ink-receptive layer of a void type containing ultrafine inorganic particles.

### SUMMARY OF THE INVENTION

An object of the present invention is to provide an ink-jet recording material having photo-like high glossiness, excellent ink-absorption property, involving no problem of crack at the time of production or crack by folding of the recording material and having high productivity, and a method for preparing the same. Also, another object of the present invention is to provide an ink-jet recording material suitable for printing with pigment ink.

The above objects of the present invention can be basically accomplished by the following inventions.

(1) An ink-jet recording material comprising a support and at least one ink-receptive layer provided on the support, wherein at least one of the ink-receptive layers contains inorganic particles having an average secondary particle size of about 500 nm or less, a resin binder having a keto group as a resin binder and a compound having two or more primary amino groups in the molecule.

(2) An ink-jet recording material for pigment ink comprising a support and at least one ink-receptive layer, wherein at least one of the ink-receptive layers contains inorganic particles having an average secondary particle size of about 500 nm or less, a resin binder having a keto group as a resin binder and a compound having two or more primary amino groups in the molecule.

(3) A method for preparing an ink-jet recording material which comprises coating, on a support, a coating solution for an ink-receptive layer containing inorganic particles having an average secondary particle size of about 500 nm or less, a resin binder having a keto group as a resin binder and a compound having two or more primary amino groups in the molecule, heating the coated solution to gel the same and then drying the same.

### DESCRIPTION OF THE PREFERRED EMBODIMENTS

In the following, the present invention will be explained in detail. In the ink-receptive layer of the present invention, inorganic particles having an average secondary particle size of 500 nm or less are used. Examples of such inorganic particles may include conventionally known various kinds of fine particles such as amorphous synthesized silica, alumina, alumina hydrate, calcium carbonate, magnesium carbonate, titanium dioxide, etc., and amorphous synthesized silica, alumina or alumina hydrate is particularly preferred in the points of glossiness, ink-absorption property and productivity.

In amorphous synthesized silica, they can be roughly classified into wet process silica, fumed silica, and others according to the preparation processes. The wet process silica can be further classified into a precipitation method silica, a gel method silica and a sol method silica according to the preparation processes. The precipitation method silica can be prepared by reacting sodium silicate and sulfuric acid under alkali conditions, silica particles grown in particle size aggregated and precipitated, and then, they are processed through filtration, washing, drying, pulverization and classification to prepare a product. As the precipitation method silica, it is commercially available from TOSOH SILICA CORPORATION (Japan) under trade-name of Nipsil, K.K. Tokuyama (Japan) under trade name of Tokusil. The gel method silica can be produced by reacting sodium silicate and sulfuric acid under acidic conditions. In this method, small silica particles are dissolved during ripening and so reprecipitated between other primary particles which are larger sized particles that primary particles are combined to each other. Thus, clear primary particles disappear and form relatively hard agglomerated particles having inner void structure. For example, it is commercially available from TOSOH SILICA CORPORATION (Japan) under trade name of Nipgel, Grace Japan Co., Ltd. (Japan) under trade names of Syloid, Sylojet, and the like. The sol method silica is also called to as colloidal silica and can be obtained by heating and ripening silica sol obtained by methathesis of sodium silicate by an acid, etc., or passing through an ion-exchange resin layer, and is commercially available from Nissan Chemical Industries, Ltd. (Japan) under trade name of SNOWTEX.

Fumed silica is also called to as the drying method silica relative to the wet process method, and it can be generally prepared by a flame hydrolysis method. More specifically, it has generally been known a method in which silicon tetrachloride is burned with hydrogen and oxygen, and a silane such as methyl trichlorosilane or trichlorosilane may be used singly in place of silicon tetrachloride or as a mixture in combination with silicon tetrachloride. The fumed silica is commercially available from Nippon Aerosil K.K. (Japan) under the trade name of Aerosil, and K.K. Tokuyama (Japan) under the trade name of QS type, etc.

In the present invention, fumed silica is particularly preferably used. An average particle size of a primary particle of the fumed silica to be used in the present invention is preferably 30 nm or less, and more preferably 15 nm or less to prepare higher glossiness. More preferred are those having an average particle size of the primary particles of 3 to 15 nm, particularly preferably 3 to 10 nm, and having a specific surface area measured by the BET method of 200 m²/g or more, more preferably 250 to 500 m²/g. The BET method mentioned in the present invention means one of methods for measuring a surface area of powder material by a gas phase adsorption method and is a method for obtaining a total surface area possessed by 1 g of a sample, i.e., a specific surface area, from an adsorption isotherm. In general, as an adsorption gas, a nitrogen gas has frequently been used, and a method of measuring an adsorption amount obtained by the change in pressure or a volume of a gas to be adsorbed has most frequently been used. Most famous equation for representing isotherm of polymolecular adsorption is a Brunauer-Emmett-Teller equation which is also called to as a BET equation and has widely been used for determining a surface area of a substance to be examined. A surface area can be obtained by measuring an adsorption amount based on the BET equation and multiplying the amount with a surface area occupied by the surface of one adsorbed molecule.

The fumed silica is preferably dispersed in the presence of a cationic compound. An average secondary particle size of the dispersed fumed silica is 500 nm or less, preferably 10 to 300 nm, more preferably 20 to 200 nm. As the dispersing method, it is preferred that fumed silica and a dispersing medium are provisionally mixed by a usual propeller stirring, turbine type stirring, homomixer type stirring, etc., and then, dispersion is carried out by using a media mill such as a ball mill, a bead mill, a sand grinder, etc., a pressure type dispersing device such as a high-pressure homogenizer, an ultra high-pressure homogenizer, etc., an ultrasonic wave dispersing device, and a thin-film spin type dispersing device, etc. The average secondary particle size of the inorganic particles mentioned in the present specification is a value obtained by observing an ink-receptive layer of the resulting recording material with an electron microscope.

In the present invention, a wet process silica pulverized to an average secondary particle size of 500 nm or less is also preferably used. The wet process silica to be used in the present invention is silica particles preferably having an average primary particle size of 50 nm or less, more preferably 3 to 40 nm, and an average agglomerated particle size (that is a particle size before pulverization) of 5 to 50 μm. In the present invention, preferably used are those in which these wet process silica are finely pulverized in the presence of a cationic compound to have an average secondary particle size of 500 nm or less, preferably about 20 to 200 nm.

Since the wet process silica produced by the conventional method has an average agglomerated particle size of 1 μm or more, this is used after finely pulverized. As the pulverization method, a wet pulverization method in which silica dispersed in an aqueous medium is mechanically pulverized is preferably used. At this time, it is preferred to use a precipitation method silica having an oil absorption amount of 210 ml/100 g or less and an average agglomerated particle size of 5 μm or more since increase in initial viscosity of the dispersion is controlled, dispersion with high solid concentration is realized and the particles can be pulverized finer due to increase in pulverization and dispersion efficiencies. By using a dispersion with a higher solid concentration, productivity of the recording paper is also improved. The oil absorption amount can be measured according to the description of JIS K-5101.

As a specific method to prepare wet process silica fine particles having an average secondary particle size of 500 nm or less of the present invention, there may be mentioned, for example, a method of mixing silica particles and a cationic compound in water (addition of the materials may be carried out either of which firstly or may be simultaneously carried out), a method of mixing respective dispersions or aqueous solutions, and then, mixing the liquid by using at least one of a saw blade type dispersing device, a propeller blade type dispersing device, and a rotor stator type dispersing device to prepare a provisional dispersion. If necessary, a suitable amount of a low boiling point solvent, etc., may be further added to the dispersion. A solid concentration of the silica provisional dispersion is preferably as high as possible, but it is too high concentration, dispersion becomes impossible, so that the solid concentration is preferably in the range of 15 to 40% by weight, more preferably 20 to 35% by weight. Next, the silica provisional dispersion obtained by the above-mentioned method is further dispersed by using a more potent mechanical means to prepare a wet process silica fine particle dispersion having an average secondary particle size of 500 nm or less. As the mechanical means, those conventionally known in the art can be employed, and there may be used, for example, a media mill such as a ball mill, a bead mill, a sand grinder, etc., a pressure type dispersing device such as a high-pressure homogenizer, an ultra high-pressure homogenizer, etc., an ultrasonic wave dispersing device, and a thin-film spin type dispersing device, etc.

As the cationic compound to be used for dispersing the above-mentioned fumed silica and the wet process silica, a cationic polymer or a water-soluble metallic compound may be used. As the cationic polymer, there may be preferably mentioned polyethyleneimine, polydiallylamine, polyallylamine, polyalkylamine, as well as polymers having a primary to tertiary amino group or a quaternary ammonium group as disclosed in Japanese Unexamined Patent Publications No. Sho. 59-20696, No. Sho. 59-33176, No. Sho. 59-33177, No. Sho. 59-155088, No. Sho. 60-11389, No. Sho. 60-49990, No. Sho. 60-83882, No. Sho. 60-109894, No. Sho. 62-198493, No. Sho. 63-49478, No. Sho. 63-115780, No. Sho. 63-280681, No. Hei. 1-40371, No. Hei. 6-234268, No. Hei. 7-125411 and No. Hei. 10-193776, etc. In particular, a diallylamine derivative is preferably used as the cationic polymer. An average molecular weight (Mw; weight average molecular weight) of these cationic polymers is preferably 2,000 to 100,000, particularly preferably in the range of 2,000 to 30,000 in the points of dispersibility and a viscosity of the dispersion.

As the water-soluble metallic compound, there may be mentioned, for example, a water-soluble polyvalent metallic salt. Of these, a compound comprising aluminum or a metal of Group 4A (Group 4) of the Periodic Table (for example, zirconium, titanium) is preferably used. A water-soluble aluminum compound is particularly preferably used. The water-soluble aluminum compound may include, for example, aluminum chloride and its hydrate, aluminum sulfate and its hydrate, aluminum alum, etc. as an inorganic salt thereof. Moreover, it has been known a basic poly(aluminum hydroxide) compound which is an inorganic aluminum-containing cationic polymer, and it is preferably used.

The above-mentioned basic poly(aluminum hydroxide) compound is a water-soluble poly(aluminum hydroxide) a main component of which is represented by the following formula (1), (2) or (3), and which contains a polynuclear condensed ion which is basic and a polymer in a stable form, such as [Al₆(OH)₁₅]³⁺, [Al₈(OH)₂₀]⁴⁺, [Al₁₃(OH)₃₄]⁵⁺, [Al₂₁(OH)₆₀]³⁺, etc.

[Al₂(OH)ₙCl₆₋ₙ]ₘ (1)

[Al(OH)₃]ₙAlCl₃ (2)

Alₙ(OH)ₘCl₍₃ₙ₋ₘ₎0<m<3n (3)

These water-soluble aluminum compounds are commercially available from Taki Chemical, K.K. (Japan) with poly(aluminum chloride) (PAC, trade name) as a water treatment agent, from Asada Chemical K.K. (Japan) with poly(aluminum hydroxide) (Paho, trade name), from K.K. Riken Green (Japan) under the trade name of Pyurakemu WT and other manufacturers with the same objects whereby various kinds of different grades can be easily obtained.

The water-soluble compound containing an element of Group 4 of the Periodic Table to be used in the present invention is more preferably a water-soluble compound containing titanium or zirconium. As the water-soluble compound containing titanium, there may be mentioned titanium chloride and titanium sulfate. As the water-soluble compound containing zirconium, there may be mentioned zirconium acetate, zirconium chloride, zirconium oxychloride, zirconium hydroxychloride, zirconium nitrate, basic zirconium carbonate, zirconium hydroxide, zirconium lactate, ammonium zirconium carbonate, potassium zirconium carbonate, zirconium sulfate, zirconium fluoride, and the like. In the present invention, the term “water-soluble” means that the compound is dissolved in water in an amount of 1% by weight or more at normal temperature under normal pressure.

As the alumina to be used in the present invention, γ-alumina that has γ-type crystal structure of aluminum oxide is preferably used, and of these, δ group crystals are particularly preferred. A primary particle size of the γ-alumina can be reduced to about 10 nm, and in usual, those of alumina having a secondary particle size of several thousands to several ten thousands nm are pulverized by an ultrasonic or high pressure homogenizer, a counter-collision type jet pulverizer, etc. to an average secondary particle size of 500 nm or less, preferably about 20 to 300 nm are preferably used.

The alumina hydrate to be used in the present invention is represented by the formula: Al₂O₃.nH₂O (n=1 to 3). When n is 1, it represents a boehmite structure alumina hydrate, and when n is more than 1 and less than 3, it represents a pseudoboehmiate structure alumina hydrate. Such alumina hydrates can be obtained by conventionally known preparation methods such as hydrolysis of aluminum alkoxide such as aluminum isopropoxide, etc., neutralization of an aluminum salt with an alkali, hydrolysis of an aluminate, etc. An average secondary particle size of the alumina hydrate to be used in the present invention is 500 nm or less, preferably 20 to 300 nm.

The above-mentioned alumina and alumina hydrate to be used in the present invention can be used in the form of a dispersion in which these compounds are dispersed by a conventionally known dispersant such as acetic acid, lactic acid, formic acid, nitric acid, etc.

The ink-receptive layer of the present invention uses a resin binder having a keto group as a resin binder of the inorganic particles. The resin binder having a keto group can be synthesized by a method in which a monomer having a keto group and other monomer(s) are copolymerized.

Examples of the monomer having a keto group may include acrolein, diacetone acrylamide, diacetone (meth)acrylate, acetoacetoxyethyl (meth)acrylate, 4-vinylacetoacetanilide, acetoacetyl allylamide, etc. Also, the keto group may be introduced by a polymer reaction, and for example, an acetoacetyl group can be introduced by the reaction of a hydroxyl group and a diketene, and the like. Examples of the resin binder having a keto group may include acetoacetyl-modified polyvinyl alcohol, acetoacetyl-modified cellulose derivatives, acetoacetyl-modified starch, diacetone acrylamide-modified polyvinyl alcohol, resin binders as disclosed in Japanese Unexamined Patent Publication No. Hei. 10-157283, etc. In the present invention, a modified polyvinyl alcohol having a keto group is particularly preferred. The modified polyvinyl alcohol having a keto group may include acetoacetyl-modified polyvinyl alcohol, diacetone acrylamide-modified polyvinyl alcohol, etc.

The acetoacetyl-modified polyvinyl alcohol can be prepared by a conventionally known method such as a reaction of polyvinyl alcohol and diketene, etc. An acetoacetylation degree thereof is preferably 0.1 to 20 mol %, more preferably 1 to 15 mol %. A saponification degree thereof is preferably 80 mol % or more, more preferably 85 mol % or more. A polymerization degree thereof is preferably 500 to 5000, particularly preferably 1000 to 4500.

The diacetone acrylamide-modified polyvinyl alcohol can be prepared by a conventionally known method such as saponification of a diacetone acrylamide-vinyl acetate copolymer, etc. A content of the diacetone acrylamide unit is preferably in the range of 0.1 to 15 mol %, more preferably 0.5 to 10 mol %. A saponification degree thereof is preferably 85 mol % or more, and a polymerization degree thereof is preferably 500 to 5000.

In the present invention, in addition to the resin binder having a keto group, other conventionally known resin binder(s) may be used in combination. For example, cellulose derivative(s) such as carboxymethyl cellulose, hydroxypropyl cellulose, etc.; starch or various kinds of modified starches; gelatin or various kinds of modified gelatins; chitosan, carrageenan, casein, soybean protein, polyvinyl alcohol or various kinds of modified polyvinyl alcohols, polyvinyl pyrrolidone, polyacrylamide, etc. may be used in combination, if necessary. Moreover, various kinds of latexes may be used in combination as a resin binder.

At this time, in the point of glossiness, a resin binder having high compatibility with the resin binder having a keto group is preferably used in combination. When the modified polyvinyl alcohol having a keto group is used, a completely or partially-saponified polyvinyl alcohol or cationically-modified polyvinyl alcohol is preferably used in combination. In particular, those having a saponification degree of 80% or more and an average polymerization degree of 200 to 5000 are preferably used.

The cationically-modified polyvinyl alcohol preferably used is a polyvinyl alcohol having a primary to tertiary amino group or a quaternary ammonium group at the main chain or side chain of the polyvinyl alcohol as disclosed in, for example, Japanese Unexamined Patent Publication No. Sho. 61-10483.

An amount of the resin binder to be used in combination is not specifically limited so long as it is in a range in which effects of the resin binder having a keto group and a compound having two or more primary amino groups in the molecule mentioned below can be obtained.

A total content of the resin binder is preferably in the range of 5 to 40% by weight based on the amount of the inorganic particles, particularly preferably 10 to 30% by weight. By making the ratio of the resin binder in the above-mentioned range, a void volume (a void ratio) of the ink-receptive layer becomes large whereby an ink-absorption property is heightened.

Next, the compound having two or more primary amino groups in the molecule to be used in the present invention is explained. The primary amino group referred to in the present invention is a primary amino group bound to a carbon atom of an aliphatic group, an aromatic group or a heterocyclic group, and a primary amino group bound to a nitrogen atom (that is, a terminal amino group of hydrazine). The primary amino groups are preferably possessed by the compound in a number of 2 to 5. In the point of thickening effects after mixing, an amino group in a hydrazine type is preferred, and that of a hydrazide, semicarbazide or carbonohydrazide structure is particular preferred. Examples of the compound having two or more primary amino groups bound to a carbon atom may include ethylene diamine, diethylene triamine, trimethylene diamine, metaxylylene diamine, norbornane diamine, 1,3-bis(aminomethyl)cyclohexane, etc. Examples of the compound having two or more hydrazine type amino groups may include hydrazine and a salt thereof, carbohydrazide; polycarboxylic acid hydrazides such as succinic dihydrazide, adipic dihydrazide, citric trihydrazide, sebacic dihydrazide, isophthalic dihydrazide, etc.; a reaction product of a polyisocyanate and hydrazine such as 4,4′-ethylenedisemicarbazide, 4,4′-hexamethylenedisemicarbazide, etc.; a polymer type hydrazide such as polyacrylic hydrazide, etc. Of these, the polycarboxylic acid hydrazide is particularly preferred in the points of water-solubility and reactivity, and succinic dihydrazide and adipic dihydrazide are most preferred.

A content of the compound having two or more primary amino groups in the molecule to be used in the present invention is not particularly limited, and it is preferably in the range of 0.1 to 50% by weight, more preferably 1 to 20% by weight based on an amount of the resin binder having a keto group in the points of productivity and characteristics of the resulting ink-receptive layer.

In the present invention, other conventionally known film hardening agent may be used in combination. When the modified polyvinyl alcohol is used as a resin binder, it is preferred to use a cross-linking agent (film hardening agent) of the polyvinyl alcohol in combination including an aldehyde type compound such as formaldehyde and glutaraldehyde; a ketone compound such as diacetyl and chloropentanedione; a compound having a reactive halogen such as bis(2-chloroethylurea), 2-hydroxy-4,6-dichloro-1,3,5-triazine, and those as disclosed in U.S. Pat. No. 3,288,775; divinylsulfone; a compound having a reactive olefin as disclosed in U.S. Pat. No. 3,635,718; a N-methylol compound as disclosed in U.S. Pat. No. 2,732,316; an isocyanate compound as disclosed in U.S. Pat. No. 3,103,437; an aziridine compound as disclosed in U.S. Pat. Nos. 3,017,280 and 2,983,611; a carbodiimide type compound as disclosed in U.S. Pat. No. 3,100,704; an epoxy compound as disclosed in U.S. Pat. No. 3,091,537; a halogen carboxyaldehyde compound such as mucochloric acid, a dioxane derivative such as dihydroxydioxane, an inorganic cross-linking agent such as chromium alum, zirconium sulfate, boric acid, a borate and borax, and they may be used independently or in combination of two or more. Of these, boric acid, borax and a borate are particularly preferred.

In the present invention, preparation of an ink-jet recording material can be preferably carried out by coating a coating solution containing inorganic particles having an average secondary particle size of about 500 nm or less, a resin binder having a keto group and a compound having two or more primary amino groups in the molecule on a support, heating the coated solution to be gelled, and then, drying. In the present invention, “gelled” means a state in which the coated solution does not flow even when wind is blown thereto in the drying step due to increase in the viscosity, and preferably a state showing substantially no fluidity.

In the present invention, after coating the coating solution onto the support, the coated solution is heated to gel the same and then dried, whereby a recording material for ink-jet having higher glossiness and good ink-absorption property can be obtained. Also, it can be dried at high temperature, so that higher productivity can be obtained as compared to the preparation process in which drying is carried out under relatively mild conditions after gelling the coated solution at low temperature using a polyvinyl alcohol and boric acid. Moreover, a boron compound such as boric acid is not required to be used, so that it is preferred in the environmental view.

As a method of heating after coating onto the support, a method of passing through high temperature air, a method of adhering to a heat roll, a method of using a microwave heating device, etc. may be used. A heating temperature may vary depending on the composition of the coating solution such as a ratio of the resin binder having a keto group and the compound having amino groups. When the coating solution is an aqueous solution, it is preferably in the range of 30 to 100° C., particularly preferably 40 to 95° C. In general, the reaction between the keto group and the amino group relatively rapidly proceeds, and, in particular, the reaction between the keto group and hydrazine or the hydrazide group proceeds rapidly, so that a heating time is preferably 1 second to 10 minutes, more preferably 5 seconds to 5 minutes in the point of productivity.

A coated amount of the ink-receptive layer of the present invention after drying is preferably in the range of 8 to 40 g/m² as a solid content of the inorganic particles, particularly preferably 10 to 30 g/m² in the points of ink-absorption property, strength of the ink-receptive layer and productivity.

In the present invention, a cationic compound is further preferably contained in the ink-receptive layer for the purpose of improvement of water-resistance of an ink dye. Examples of the cationic compound may include the cationic polymer and the water-soluble metallic compound mentioned in the explanation of dispersion of the silica. Examples of the water-soluble metallic compound may include a water-soluble salt of a metal selected from the group consisting of calcium, barium, manganese, copper, cobalt, nickel, aluminum, iron, zinc, chromium, magnesium, tungsten and molybdenum. More specifically, such a water-soluble metallic compound may include, for example, calcium acetate, calcium chloride, calcium formate, calcium sulfate, barium acetate, barium sulfate, barium phosphate, manganese chloride, manganese acetate, manganese formate dihydrate, ammonium manganese sulfate hexahydrate, cupric chloride, copper (II) ammonium chloride dihydrate, copper sulfate, cobalt chloride, cobalt thiocyanate, cobalt sulfate, nickel sulfate hexahydrate, nickel chloride hexahydrate, nickel acetate tetrahydrate, ammonium nickel sulfate hexahydrate, amide nickel sulfate tetrahydrate, ferrous bromide, ferrous chloride, ferric chloride, ferrous sulfate, ferric sulfate, zinc bromide, zinc chloride, zinc nitrate hexahydrate, zinc sulfate, zinc p-phenolsulfonate, chromium acetate, chromium sulfate, magnesium sulfate, magnesium chloride hexahydrate, magnesium citrate nonahydrate, sodium phosphorus wolframate, tungsten sodium citrate, dodecawolframmatophosphate n hydrate, dodecawolframatosilicate 26 hydrate, molybdenum chloride, dodecamolybdatephosphate n hydrate, etc. Of these, a cationic polymer having a molecular weight (Mw) of 5,000 to 100,000, and a compound comprising aluminum or a metal of Group 4A (Group 4) of the Periodic Table (for example, zirconium, titanium) are preferably used, and a water-soluble aluminum compound is particularly preferably used. The cationic compound may be used singly or in combination of two or more compounds.

In the ink-jet recording material of the present invention, in addition to at least one of the above-mentioned ink-receptive layers, an ink-absorption layer with the other constitution or a layer having other function such as a protective layer may be further provided.

In the present invention, to the respective ink-receptive layers, various kinds of conventionally known additives such as a surfactant, a coloring dye, a coloring pigment, a fixing agent of an ink dye, an UV absorber, an antioxidant, a dispersant of the pigment, an antifoaming agent, a leveling agent, an antiseptic agent, a fluorescent brightener, a viscosity stabilizer, a pH buffer, etc. may be added.

As a support to be used in the present invention, there may be mentioned, for example, a non-water absorptive support such as a film of a polyethylene, polypropylene, polyvinyl chloride, a diacetate resin, a triacetate resin, cellophane, an acryl resin, polyethylene terephthalate, polyethylene naphthalate, etc., and a polyolefin resin-coated paper, etc., a water-absorptive paper such as uncoated paper, art paper, coated paper, cast-coated paper, and the like. Of these, a non-water absorptive support is preferably used, and among the non-water absorptive support, a polyolefin resin-coated paper is particularly preferably used. A thickness of the support is preferably about 50 μm to about 250 μm.

When a non-water absorptive support such as a film or a resin-coated paper is used, a primer layer mainly comprising a natural polymer compound or a synthetic resin is preferably provided on the surface of the support on which the ink-receptive layer is to be provided. Such a synthetic resin may include an acryl resin, a polyester resin, a vinylidene chloride resin, a vinyl chloride resin, a vinyl acetate resin, polystyrene, a polyamide resin, a polyurethane resin, etc. The primer layer is provided on the support with a thickness (dried thickness) in the range of 0.01 to 5 μm, preferably 0.01 to 2 μm.

To the support of the present invention, various kinds of back coating layer(s) may be provided for the purpose of providing writability, antistatic property, conveying property, anticurl property, etc. In the back coating layer, an inorganic antistatic agent, an organic antistatic agent, a hydrophilic binder, a latex, an anticuring agent, a pigment, a curing agent, a surfactant, etc. may be included in an optional combination.

When a coating solution for an ink-receptive layer is provided on a film support or a resin-coated paper support, it is preferred to carry out a corona discharge treatment, flame treatment, UV ray irradiation treatment, plasma treatment and the like prior to provision of the coating.

In the present invention, the coating method of the respective layers constituting the ink-receptive layers is not particularly limited and a conventionally known coating method may be used. For example, there may be mentioned a slide bead system, a curtain system, an extrusion system, an air knife system, a roll coating system, a rod bar coating system, etc.

Ink to be used for ink-jet recording can be roughly classified into dye ink and pigment ink, and they may be used depending on the purpose of objects and uses. The dye ink is ink using a water-soluble dye as a coloring agent, and the pigment ink is ink using a water-dispersible pigment as a coloring agent. The ink-jet recording material of the present invention is suitable for both of the inks as shown in Example 1 (using the dye ink) and Example 2 (using the pigment ink) as mentioned below. However, as shown in Example 2, when a recording sheet printed by using the pigment ink is stored by filing in an album, there is a problem specific for the pigment ink in which an image portion (a film formed by the pigment ink) cracks, and the ink-jet recording material of the present invention is extremely effective for this problem.

### EXAMPLES

In the following, the present invention is explained in more detail by referring to Examples, but the present invention is not limited by these Examples. Incidentally, all “part(s)” and “%” mean “part(s) by weight” and “% by weight” of a solid component, respectively.

### Example 1

<Preparation of Paper Support Coated with Polyolefin Resin>

A mixture of a bleached kraft pulp of hardwood (LBKP) and a bleached sulfite pulp of softwood (NBSP) with a weight ratio of 1:1 was subjected to beating until it becomes 300 ml by the Canadian Standard Freeness to prepare a pulp slurry. To the slurry were added alkyl ketene dimer in an amount of 0.5% based on the amount of the pulp as a sizing agent, polyacrylamide in an amount of 1.0% based on the same as a strengthening additive of paper, cationic starch in an amount of 2.0% based on the same, and a polyamide epichlorohydrin resin in an amount of 0.5% based on the same, and the mixture was diluted with water to prepare a 1% slurry. This slurry was made paper by a tourdrinier paper machine to have a basis weight of 170 g/m², dried and subjected to moisture conditioning to prepare a base paper for a polyolefin resin-coated paper. A polyethylene resin composition comprising 100 parts of a low density poly- ethylene having a density of 0.918 g/cm³ and 10 parts of anatase type titanium oxide dispersed uniformly in the resin was melted at 320° C. and the melted resin composition was subjected to extrusion coating on a surface of the above-mentioned base paper with a thickness of 35 μm by 200 m/min and subjected to extrusion coating by using a cooling roller subjected to slightly roughening treatment. On the other surface of the base paper, a blended resin composition comprising 70 parts by weight of a high density polyethylene resin having a density of 0.962 g/cm³ and 30 parts by weight of a low density polyethylene resin having a density of 0.918 g/cm³ was melted similarly at 320° C. and the melted resin composition was subjected to extrusion coating with a thickness of 30 μm and subjected to extrusion coating by using a cooling roller subjected to roughening treatment.

Onto the front surface of the above-mentioned polyolefin resin-coated paper was subjected to a high frequency corona discharge treatment, and then, a coating solution for forming a primer layer was coated thereon to have a gelatin amount of 50 mg/m² (about 0.05 μm) and dried to prepare a support.

<Primer layer>

| | |
|---|---|
| Lime-treated gelatin | 100 parts |
| 2-Ethylhexyl sulfosuccinate | 2 parts |
| Chromium alum | 10 parts |

<Recording Sheet 1>

To water were added 4 parts of a dimethyldiallyl ammonium chloride homopolymer (molecular weight (Mw): 9,000) and 100 parts of fumed silica (average primary particle size: 7 nm, specific surface area: 300 m²/g) to prepare a provisional dispersion, and the dispersion was treated by using a high pressure homogenizer to prepare Silica dispersion 1 with a solid concentration of 20%. This Silica dispersion 1 and other chemicals shown below dissolved in water were mixed at 30° C. to prepare Coating solution 1 for an ink-receptive layer with the following composition. This Coating solution 1 was coated on the above-mentioned support with a wire bar so that the coated amount of the silica particles became 20 g/m², firstly heated at 80° C. for 15 seconds to gel the coated solution, and then, dried by successively blowing air at 80° C. and then 55° C. Incidentally, by an electron microscopic observation, an average secondary particle size of silica fine particles was 80 nm.

<Coating solution 1 for ink-receptive layer>

| | | |
|---|---|---|
| Silica dispersion 1 (as silica solid content) | 100 | parts |
| Acetoacetyl-modified polyvinyl alcohol | 22 | parts |
| (Acetoacetylation degree: 3%, Saponification degree: 98%, | | |
| average polymerization degree: 2500) | | |
| Adipic dihydrazide | 2 | parts |

<Recording Sheet 2>

To water were added 4 parts of a dimethyldiallyl ammonium chloride homopolymer (molecular weight (Mw): 9,000) and 100 parts of precipitated silica (oil absorption amount: 200 ml/100 g, average primary particle size: 16 nm, average agglomeration particle size: 9 μm), and the mixture was dispersed by using a saw blade type dispersing device (blade rim speed: 30 m/sec) to prepare a provisional dispersion. Next, the obtained provisional dispersion was treated by a bead mill to prepare Silica dispersion 2 with a solid concentration of 30%. This Silica dispersion 2 and other chemicals shown below dissolved in water were mixed at 30° C. to prepare Coating solution 2 for an ink-receptive layer with the following composition. This Coating solution 2 was coated on the above-mentioned support with a wire bar so that the coated amount of the silica particles became 20 g/m², and then, dried in the same manner as in Recording sheet 1 to prepare Recording sheet 2. Incidentally, by an electron microscopic observation, an average secondary particle size of silica fine particles was 100 nm.

<Coating solution 2 for ink-receptive layer>

| | | |
|---|---|---|
| Silica dispersion 2 (as silica solid content) | 100 | parts |
| Acetoacetyl-modified polyvinyl alcohol | 16 | parts |
| (Acetoacetylation degree: 3%, Saponification degree: 98%, | | |
| average polymerization degree: 2500) | | |
| Adipic dihydrazide | 1.5 | parts |

<Recording Sheet 3>

To water were added 2 parts of nitric acid and 100 parts of pseudoboehmite (average primary particle size: 14 nm), and the mixture was dispersed by using a saw blade type dispersing device to prepare an alumina hydrate dispersion with a solid concentration of 20%. This alumina hydrate dispersion and other chemicals shown below dissolved in water were mixed at 30° C. to prepare Coating solution 3 for an ink-receptive layer with the following composition. This Coating solution 3 was coated on the above-mentioned support with a wire bar, so that the coated amount of the alumina hydrate particles became 20 g/m², and then, dried in the same manner as in Recording sheet 1 to prepare Recording sheet 3. Incidentally, by an electron microscopic observation, an average secondary particle size of alumina hydrate particles was 80 nm.

<Coating solution 3 for ink-receptive layer>

| | | |
|---|---|---|
| Alumina hydrate dispersion 2 (as alumina hydrate solid | 100 | parts |
| content) | | |
| Acetoacetyl-modified polyvinyl alcohol | 12 | parts |
| (Acetoacetylation degree: 3%, Saponification degree: 98%, | | |
| average polymerization degree: 2500) | | |
| Adipic dihydrazide | 1.2 | parts |

<Recording Sheet 4>

Recording sheet 4 was prepared in the same manner as in Recording sheet 1 except for changing the binder component of the above-mentioned Coating solution 1 for ink-receptive layer to 25 parts of diacetone acrylamide-modified polyvinyl alcohol (diacetone acrylamide-modification degree: 5%, Saponification degree: 98%, average polymerizetion degree: 1700). Incidentally, by an electron microscopic observation, an average secondary particle size of silica fine particles was 80 nm.

<Recording Sheet 5>

Recording sheet 5 was prepared in the same manner as in Recording sheet 1 except for changing the adipic dihydrazide of the above-mentioned Coating solution 1 for ink-receptive layer to 1.7 parts of succinic dihydrazide. Incidentally, by an electron microscopic observation, an average secondary particle size of silica fine particles was 80 nm.

<Recording sheet 6>

Recording sheet 6 was prepared in the same manner as in Recording sheet 1 except for changing the binder component of the above-mentioned Coating solution 1 for ink-receptive layer to 22 parts of partially saponified polyvinyl alcohol (Saponification degree: 88%, average polymerization degree: 3500). Incidentally, by an electron microscopic observation, an average secondary particle size of silica fine particles was 80 nm.

<Recording sheet 7>

Recording sheet 7 was prepared in the same manner as in Recording sheet 1 except for changing the adipic dihydrazide of the above-mentioned Coating solution 1 for ink-receptive layer to 2 parts of boric acid. Incidentally, by an electron microscopic observation, an average secondary particle size of silica fine particles was 80 nm.

<Recording sheet 8>

Recording sheet 8 was prepared in the same manner as in Recording sheet 1 except for changing the binder component of the above-mentioned Coating solution 1 for ink-receptive layer to 22 parts of partially saponified polyvinyl alcohol (Saponification degree: 88%, average polymerization degree: 3500) and replacing the adipic dihydrazide with 2 parts of boric acid. Incidentally, by an electron microscopic observation, an average secondary particle size of silica fine particles was 80 nm.

<Recording sheet 9>

Recording sheet 9 was prepared in the same manner as in Recording sheet 1 except for changing the adipic dihydrazide of the above-mentioned Coating solution 1 for ink-receptive layer to 2 parts of propionic hydrazide. Incidentally, by an electron microscopic observation, an average secondary particle size of silica fine particles was 80 nm.

<Recording sheet 10>

To water were added 4 parts of a dimethyldiallyl ammonium chloride homopolymer (molecular weight (Mw): 9,000) and 100 parts of precipitated silica (oil absorption amount: 250 ml/100 g, average primary particle size: 30 nm, average agglomeration particle size: 2 μm), and the mixture was dispersed by using a saw blade type dispersing device (blade rim speed: 30 m/sec) to prepare Silica dispersion 3. This Silica dispersion 3 and other chemicals shown below dissolved in water were mixed at 30° C. to prepare Coating solution 4 for an ink-receptive layer with the following composition. This Coating solution 4 was coated on the above-mentioned support with a wire bar so that the coated amount of the silica particles became 20 g/m², and then, dried in the same manner as in Recording sheet 1 to prepare Recording sheet 10. Incidentally, by an electron microscopic observation, an average secondary particle size of silica fine particles was 1.0 μm.

<Coating solution 4 for ink-receptive layer>

| | | |
|---|---|---|
| Silica dispersion 3 (as silica solid content) | 100 | parts |
| Acetoacetyl-modified polyvinyl alcohol | 16 | parts |
| (Acetoacetylation degree: 3%, Saponification degree: 98%, | | |
| average polymerization degree: 2500) | | |
| Adipic dihydrazide | 1.5 | parts |

<Recording Sheet 11>

The same coating solution for an ink-receptive layer used for preparing Recording sheet 8 was applied onto the above-mentioned support with a wire bar so that a coated amount of the silica particles became 20 g/m². Then, the coated solution was firstly cooled at 10° C. for 30 seconds to increase the viscosity of the coated solution, and then, dried by blowing air at 40° C. to prepare Recording sheet 11. Incidentally, by an electron microscopic observation, an average secondary particle size of silica fine particles was 80 nm.

<Recording Sheet 12>

Recording sheet 12 was prepared in the same manner as in Recording sheet 11 except for changing the drying conditions of the coated solution to the conditions in which the coated solution was firstly cooled at 10° C. for 30 seconds to increase the viscosity of the coated solution, and then, dried by blowing air at 60° C. Incidentally, by an electron microscopic observation, an average secondary particle size of silica fine particles was 80 nm.

<Recording Sheet 13>

Recording sheet 13 was prepared in the same manner as in Recording sheet 10 except for not using the adipic dihydrazide in the above-mentioned Coating solution 4 used for preparing Recording sheet 10. Incidentally, by an electron microscopic observation, an average secondary particle size of silica fine particles was 1.0 μm.

<Recording Sheet 14>

Recording sheet 14 was prepared in the same manner as in Recording sheet 1 except for changing the adipic dihydrazide in the above-mentioned Coating solution 1 used for preparing Recording sheet 1 to formaldehyde. Incidentally, by an electron microscopic observation, an average secondary particle size of silica fine particles was 80 nm.

<Recording Sheet 15>

Recording sheet 15 was prepared in the same manner as in Recording sheet 1 except for changing the adipic dihydrazide in the above-mentioned Coating solution 1 used for preparing Recording sheet 1 to glyoxal. Incidentally, by an electron microscopic observation, an average secondary particle size of silica fine particles was 80 nm.

<Recording sheet 16>

Recording sheet 16 was prepared in the same manner as in Recording sheet 1 except for changing the adipic dihydrazide in the above-mentioned Coating solution 1 used for preparing Recording sheet 1 to dimethylolurea. Incidentally, by an electron microscopic observation, an average secondary particle size of silica fine particles was 80 nm.

<Recording Sheet 17>

Recording sheet 17 was prepared in the same manner as in Recording sheet 1 except for changing the Coating solution 1 for an ink-receptive layer to a polymer type Coating solution 5 for an ink-receptive layer. A coated amount of the acetoacetyl-modified polyvinyl alcohol was 20 g/m².

<Coating solution 5 for ink-receptive layer>

| | |
|---|---|
| Acetoacetyl-modified polyvinyl alcohol | 22 parts |
| (Acetoacetylation degree: 3%, Saponification degree: 98%, | |
| average polymerization degree: 2500) | |
| Adipic dihydrazide | 2 parts |

With regard to the respective ink-jet recording sheets thus obtained, the following evaluation was carried out. The results are shown in Table 1.

<Evaluation of Coating Defect (Cracks)>

A coated surface of the coated and dried ink-receptive layer was observed with naked eyes and evaluated by the following criteria.

◯: No coating defect observed and the coated surface was uniform.

Δ: Pale coating strips which could be hardly observed with naked eyes occurred.

×: Large cracks which could be clearly observed with naked eyes occurred.

<Glossiness at White Portion>

Glossiness at the white paper portion of the recording sheet before printing was observed with inclined light and evaluated by the following criteria.

◯: It possesses high glossy feeling as that of a color photography.

Δ: There is a little glossy feeling.

×: There is no glossy feeling.

<Ink-absorption Property>

By using a commercially available ink-jet printer (PM-950C, trade name, available from Seiko Epson K.K., Japan, which uses dye inks), solid printing with red, blue, green or black color was each carried out, and immediately after the printing, a PPC paper was overlapped over the printed portion with a slight pressurization, and the degree of an amount of the ink transferred to the PPC paper was observed with naked eyes and evaluated by the following criteria.

◯: No transfer was observed.

Δ: Pale transfer was observed at the whole part of the printed portion.

×: Dark transfer was observed at the whole part of the printed portion.

××: Ink was spread on the whole ink-receptive layer.

<Property of Crack by Folding>

When a recording sheet not yet printed was folding by making the printing surface up, whether cracks generate or not was observed with naked eyes. Incidentally, a recording sheet on the surface of which cracks generated originally (before folding) or a recording sheet the surface of which was matte state and thus no crack could be confirmed was evaluated to be “unable to evaluate” (In the table, it was shown as “-”).

◯: No crack generated.

×: Cracks generated.

TABLE 1

| | | White | Ink- | Crack | |
|---|---|---|---|---|---|
| Recording | | portion | absorption | by | |
| sheet | Cracking | glossiness | property | folding | Remarks |
| 1 | ◯ | ◯ | ◯ | ◯ | This invention |
| 2 | ◯ | ◯ | ◯ | ◯ | This invention |
| 3 | ◯ | ◯ | ◯ | ◯ | This invention |
| 4 | ◯ | ◯ | ◯ | ◯ | This invention |
| 5 | ◯ | ◯ | ◯ | ◯ | This invention |
| 6 | X | Δ | X | — | Comparative |
| 7 | Δ | Δ | Δ | — | Comparative |
| 8 | Δ | Δ | Δ | — | Comparative |
| 9 | X | X | X | — | Comparative |
| 10 | ◯ | X | ◯ | — | Comparative |
| 11 | ◯ | ◯ | ◯ | X | Comparative |
| 12 | X | Δ | ◯ | — | Comparative |
| 13 | ◯ | X | ◯ | — | Comparative |
| 14 | X | Δ | Δ | — | Comparative |
| 15 | X | Δ | Δ | — | Comparative |
| 16 | X | Δ | Δ | — | Comparative |
| 17 | ◯ | ◯ | XX | ◯ | Comparative |

From the results as mentioned above, it can be understood that ink-jet recording materials having high glossiness and good ink-absorption property and generating no crack by folding can be obtained without cracks. Also, according to the preparation method of the present invention, the ink-receptive layer applied onto the support can be dried at high temperature, so that a drying time can be shortened with a large extent whereby a production efficiency is markedly improved. Recording sheet 6 is a sheet in which the acetoacetyl-modified polyvinyl alcohol had been changed to an unmodified polyvinyl alcohol, and large cracks generated. Recording sheets 7 and 8 are sheets using boric acid as a film-hardening agent, and small cracks generated on the whole surfaces thereof. Recording sheet 9 is a sheet in which a compound having an amino group in the molecule has been used, and large cracks generated on the whole surfaces thereof. Recording sheet 10 is a sheet in which inorganic particles having an average secondary particle size of 1.0 μm have been used, and glossiness was markedly lowered. Recording sheet 11 is a sheet in which polyvinyl alcohol and boric acid have been used and prepared by gelling at low temperature and drying under relatively moderate conditions, and an ink-jet recording material having high glossiness without cracks could be obtained, but about twice of time for preparation as that of Recording sheets 1 to 10 (3 to 4 minutes) have been required due to low temperature drying, and crack by folding occurred. Recording sheet 12 is a sheet in which drying temperature after gellation by cooling was raised than that of Recording sheet 11 to heighten productivity, and the drying time could be shortened (1.5 times as compared to those of Recording sheets 1 to 10) as compared to that of Recording sheet 11, but cracks occurred on the whole surface and glossiness was lowered. Recording sheet 13 is a sheet in which large sized inorganic particles (having an average secondary particle size of 1.0 μm) larger than those having 500 nm were used, and it can be understood that no crack occurs, but glossiness was lowered. Recording sheets 14 to 16 are sheets in which other cross-linking agents than those of the present invention were used, and it can be understood that occurrence of cracks cannot be prevented by the other cross-linking agents. Recording sheets 17 employs a polymer type ink-receptive layer containing no inorganic particles, and high ink-absorption property could not be obtained.

### Example 2

Printing was carried out onto Recording sheets 1 to 17 obtained in Example 1 using pigment ink. Test method and test results are shown below.

<Ink-absorption Property>

By using an commercially available ink-jet printer using pigment ink, solid printing with C (cyan), M (magenta), Y (yellow), K (black), R (red), G (green) and B (blue) inks was each carried out with the maximum ink spreading amount, and immediately after the printing, a PPC paper was over-lapped over the printed portion with a slight pressurizetion, and the degree of an amount of the ink transferred to the PPC paper was observed with naked eyes and evaluated by the following criteria. In the table, the worst result was employed.

◯: No transfer was observed.

Δ: Ink was transferred slightly.

×: Transfer is remarkable and it cannot be practically used.

××: Ink was spread on the whole ink-receptive layer.

<Crack of Pigment Ink>

A sample printed with the above-mentioned black color pigment ink was stored in an album, and after a lapse of 30 days, that in which cracks could be markedly observed in the pigment ink was evaluated to as ×, that in which it was in an acceptable limit but cracks could be observed was evaluated to as Δ, that in which no crack could be observed was evaluated to as ◯.

TABLE 2

| Recording | Ink-absorption | Crack of | |
|---|---|---|---|
| sheet | property | pigment ink | Remarks |
| 1 | ◯ | ◯ | This invention |
| 2 | ◯ | ◯ | This invention |
| 3 | ◯ | ◯ | This invention |
| 4 | ◯ | ◯ | This invention |
| 5 | ◯ | ◯ | This invention |
| 6 | X | X | Comparative |
| 7 | Δ | Δ | Comparative |
| 8 | Δ | Δ | Comparative |
| 9 | X | X | Comparative |
| 10 | ◯ | Δ | Comparative |
| 11 | ◯ | Δ | Comparative |
| 12 | ◯ | Δ | Comparative |
| 13 | ◯ | Δ | Comparative |
| 14 | Δ | Δ | Comparative |
| 15 | Δ | Δ | Comparative |
| 16 | Δ | Δ | Comparative |
| 17 | XX | Unable to | Comparative |
| | | evaluate | |

1. An ink-jet recording material comprising a support and at least one ink-receptive layer provided on the support, wherein at least one of the ink-receptive layers contains inorganic particles having an average secondary particle size of about 500 nm or less, a resin binder having a keto group as a resin binder and a compound having two or more primary amino groups in the molecule.

2. The ink-jet recording material according to claim 1, wherein the resin binder having a keto group is a modified polyvinyl alcohol having a keto group.

3. The ink-jet recording material according to claim 2, wherein the modified polyvinyl alcohol having a keto group is at least one selected from the group consisting of an acetoacetyl-modified polyvinyl alcohol and a diacetone acrylamide-modified polyvinyl alcohol.

4. The ink-jet recording material according to claim 1, wherein the compound having two or more primary amino groups in the molecule is a compound having two or more hydrazide group in the molecule.

5. The ink-jet recording material according to claim 4, wherein the compound having two or more hydrazide group in the molecule is a polycarboxylic acid hydrazide.

6. The ink-jet recording material according to claim 5, wherein the polycarboxylic acid hydrazide is at least one selected from the group consisting of succinic dihydrazide, adipic dihydrazide, citric trihydrazide, sebacic dihydrazide and isophthalic dihydrazide.

7. The ink-jet recording material according to claim 1, wherein a ratio B/A of a total amount B of the resin binder based on an amount A of the inorganic particles in the ink-receptive layer is 5 to 40% by weight.

8. The ink-jet recording material according to claim 1, wherein a ratio B/A of a total amount B of the resin binder based on an amount A of the inorganic particles in the ink-receptive layer is 10 to 30% by weight.

9. The ink-jet recording material according to claim 1, wherein a ratio D/C of an amount D of the compound having two or more primary amino group in the molecule based on an amount C of the resin binder having a keto group in the molecule is 0.1 to 50% by weight.

10. The ink-jet recording material according to claim 1, wherein a ratio D/C of an amount D of the compound having two or more primary amino group in the molecule based on an amount C of the resin binder having a keto group in the molecule is 1 to 20% by weight.

11. The ink-jet recording material according to claim 1, wherein the inorganic particles are inorganic particles obtained by pulverizing or dispersing fumed silica or wet process silica in the presence of a cationic compound.

12. The ink-jet recording material according to claim 1, wherein the inorganic particles are inorganic particles obtained by pulverizing or dispersing fumed silica or wet process silica in the presence of a cationic compound to have an average secondary particle size of about 20 to 200 nm.

13. The ink-jet recording material according to claim 1, wherein the inorganic particles are alumina or alumina hydrate.

14. The ink-jet recording material according to claim 1, wherein the support is a non-water absorptive support.

15. The ink-jet recording material according to claim 14, wherein the non-water absorptive support is a polyolefin resin-coated paper.

16. An ink-jet recording material for pigment ink comprising a support and at least one ink-receptive layer, wherein at least one of the ink-receptive layers contains inorganic particles having an average secondary particle size of about 500 nm or less, a resin binder having a keto group as a resin binder and a compound having two or more primary amino groups in the molecule.

17. A method for preparing an ink-jet recording material which comprises coating, on a support, a coating solution for an ink-receptive layer containing inorganic particles having an average secondary particle size of about 500 nm or less, a resin binder having a keto group as a resin binder and a compound having two or more primary amino groups in the molecule, heating the coated solution to gel the same and then drying the same.
